(19) United States
(12) Patent Application Publication
(10) Pub. No.: US 2023/0126242 A1
(43) Pub. Date: Apr. 27, 2023

(54) CELL IMAGE PROCESSING SYSTEM AND CELL IMAGE PROCESSING METHOD

(71) Applicant: SHIMADZU CORPORATION, Kyoto (JP)

(72) Inventors: Ryuji SAWADA, Kyoto (JP); Shuhei YAMAMOTO, Kyoto (JP); Takeshi ONO, Kyoto (JP)

(73) Assignee: SHIMADZU CORPORATION, Kyoto (JP)

(21) Appl. No.: 18/046,178

(22) Filed: Oct. 13, 2022

(30) Foreign Application Priority Data
Oct. 22, 2021 (JP) 2021-172838

(51) Int. Cl. G06V 10/94; G06V 20/69; G06F 3/0482

(52) U.S. Cl. CPC G06V 10/945; G06V 20/698; G06V 20/693; G06F 3/0482; G06V 2201/03

(57) ABSTRACT

A cell image processing system includes a cell image processing device, a display terminal, and an input unit. The cell image processing device includes an acquisition unit that acquires cell image related data, a storage unit, a data tree creating unit that creates a data tree, and a control unit that performs control to popup display the cell image related data selected by first selection by the input unit in the data tree.

### CROSS-REFERENCE TO RELATED APPLICATIONS

The related application number JP2021-172838, Cell Image Processing System and Cell Image Processing Method, Oct. 22, 2021, Ryuji Sawada, Shuhei Yamamoto, Takeshi Ono upon which this patent application is based is hereby incorporated by reference.

### BACKGROUND OF THE INVENTION

### Field of the Invention

The present invention relates to a cell image processing system and a cell image processing method.

### Background Art

In the related art, a cell image processing system for analyzing a cell image is known. Such a system is disclosed in, for example, International Publication WO. 2020/031243.

International Publication WO. 2020/031243 discloses an image analysis device that analyzes a cell image obtained by imaging a cell. The image analysis device is configured to perform a cell related segmentation process (a process of performing division on an area) on an analysis image obtained by imaging the cell. The image analysis device creates label images obtained by performing division on the cell image into the areas of the cells to be detected by the segmentation process.

Although not disclosed in International Publication No. 2020/031243, cell image related data, such as the cell image or an analysis result obtained by analyzing the cell image, is displayed in a predetermined display area of a display unit. A plurality of cell image related data selected by a user may be displayed in the display area of the display unit.

However, for example, in a configuration in which all of the plurality of selected cell image related data are collectively displayed in the display area of the display unit, each of the cell image related data may need to be displayed in a reduced display size in order to display all of the plurality of cell image related data. In this case, since each of the displayed cell image related data is reduced, it may be difficult for the user to visually recognize the displayed cell image related data. Further, for example, in a configuration in which the plurality of selected cell image related data are vertically arranged and displayed in order in the display area of the display unit, the user can visually recognize each of the plurality of selected cell image related data in order by scrolling a screen. However, in this case, since the cell image related data are displayed in the display area in order by a scrolling operation, it is difficult to simultaneously display each of the plurality of cell image related data in the display area. Therefore, it is desired that the desired cell image related data can be visually recognized more easily and a cell image analysis work can be performed more efficiently.

### SUMMARY OF THE INVENTION

The present invention has been made to solve the above-described problems, and one object of the present invention is to provide a cell image processing system and a cell image processing method that can visually recognize desired cell image related data more easily and can more efficiently perform a cell image analysis work.

In order to achieve the above object, according to a first aspect of the invention, there is provided a cell image processing system including a cell image processing device; a display terminal that is configured to be able to communicate with the cell image processing device; and an input unit that is connected to the display terminal, in which the cell image processing device includes an acquisition unit that acquires cell image related data, a storage unit that stores relative data including the acquired cell image related data and one or more pieces of accompanying information, a data tree creating unit that creates a data tree for classifying the cell image related data into two or more hierarchies based on the accompanying information included in the relative data and displaying a name of the cell image related data in a predetermined hierarchy, and a control unit that performs control to display the data tree on the display terminal and popup display, on the display terminal, the cell image related data selected by first selection by the input unit in the data tree displayed on the display terminal.

Further, in order to achieve the above object, according to a second aspect of the invention, there is provided a cell image processing method including acquiring cell image related data; storing relative data including the acquired cell image related data and one or more pieces of accompanying information; creating a data tree for classifying the cell image related data into two or more hierarchies based on the accompanying information included in the relative data and displaying a name of the cell image related data in a predetermined hierarchy; displaying the created data tree on a display terminal; and popup displaying, on the display terminal, the selected cell image related data when the cell image related data is selected in the data tree displayed on the display terminal by an input unit.

In the cell image processing system according to the first aspect, as described above, the control unit performs control to popup display, on the display terminal, the cell image related data selected by the first selection by the input unit in the data tree displayed on the display terminal. As a result, the cell image related data selected by the first selection can be popup displayed. Therefore, compared with a case where the cell image related data is displayed in a reduced size, the cell image related data can be displayed in a large display size, so that the visibility of the cell image related data can be improved. Further, compared with a case where the plurality of cell image related data are displayed in order by a scrolling operation, the desired cell image related data can be displayed immediately, so that cell image related data desired to be checked and cell image related data desired to be compared can be visually recognized easily. As a result, the desired cell image related data can be visually recognized more easily and the cell image analysis work can be performed more efficiently.

Further, in the cell image processing method according to the second aspect, as described above, the selected cell image related data popup displayed on the display terminal when the cell image related data is selected in the data tree displayed on the display terminal by the input unit. As a result, the selected cell image related data can be popup displayed. Therefore, compared with a case where the cell image related data is displayed in a reduced size, the cell image related data can be displayed in a large display size, so that the visibility of the cell image related data can be improved. Further, compared with a case where the plurality of cell image related data are displayed in order by a scrolling operation, the desired cell image related data can be displayed immediately, so that cell image related data desired to be checked and cell image related data desired to be compared can be visually recognized easily. Therefore, the desired cell image related data can be visually recognized more easily and a cell image analysis work can be performed more efficiently.

### BRIEF DESCRIPTION OF THE DRAWINGS

FIG. 1 is a schematic diagram showing an overall configuration of a cell image processing system according to an embodiment.

FIG. 2 is a schematic diagram showing an example of a display aspect of a display unit provided in the cell image processing system.

FIG. 3 is a schematic diagram showing another example of the display aspect of the display unit included in the cell image processing system.

FIG. 4 is a diagram for explaining functional blocks of a processor included in a cell image processing device.

FIG. 5 is a schematic diagram showing an example of an analysis result.

FIG. 6 is a schematic diagram showing another example of the analysis result.

FIG. 7 is a schematic diagram for explaining a screen for inputting accompanying information in generation of relative data.

FIG. 8 is a schematic diagram for explaining a data tree created by a data tree creating unit.

FIG. 9 is a schematic diagram for explaining the data tree when priority is changed.

FIG. 10 is a flowchart for explaining a popup display process according to the embodiment.

### DETAILED DESCRIPTION OF THE INVENTION

Hereinafter, an embodiment embodying the present invention will be described with reference to the drawings.

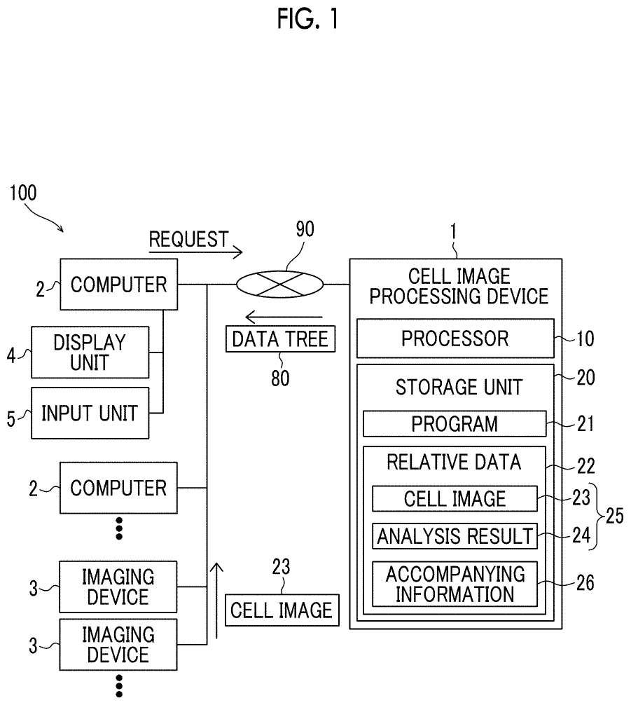

A configuration of a cell image processing system 100 according to the embodiment will be described with reference to FIG. 1. The cell image processing system 100 is a cell image processing system 100 that analyzes a cell image 23.

### Configuration of Cell Image Processing System

The cell image processing system 100 includes a cell image processing device 1, a computer 2, and an imaging device 3, as shown in FIG. 1.

FIG. 1 shows an example of the cell image processing system 100 constructed in a client-server model. The computer 2 functions as a client terminal in the cell image processing system 100. The cell image processing device 1 functions as a server in the cell image processing system 100. The cell image processing device 1, the computer 2, and the imaging device 3 are connected via a network 90 so as to be able to communicate with each other. The cell image processing device 1 performs various types of information processing in response to a request (processing request) from the computer 2 operated by a user.

The cell image processing device 1 analyzes the cell image 23 and generates an analysis result 24 in response to the request. For example, the cell image processing device 1 analyzes whether a cell appearing in the cell image 23 is differentiated or remains undifferentiated, and generates the analysis result 24. Further, the cell image processing device 1 also generates relative data 22. The relative data 22 includes cell image related data 25, and one or more pieces of accompanying information 26. The cell image related data 25 includes the cell image 23 and the analysis result 24 obtained by analyzing the cell image 23.

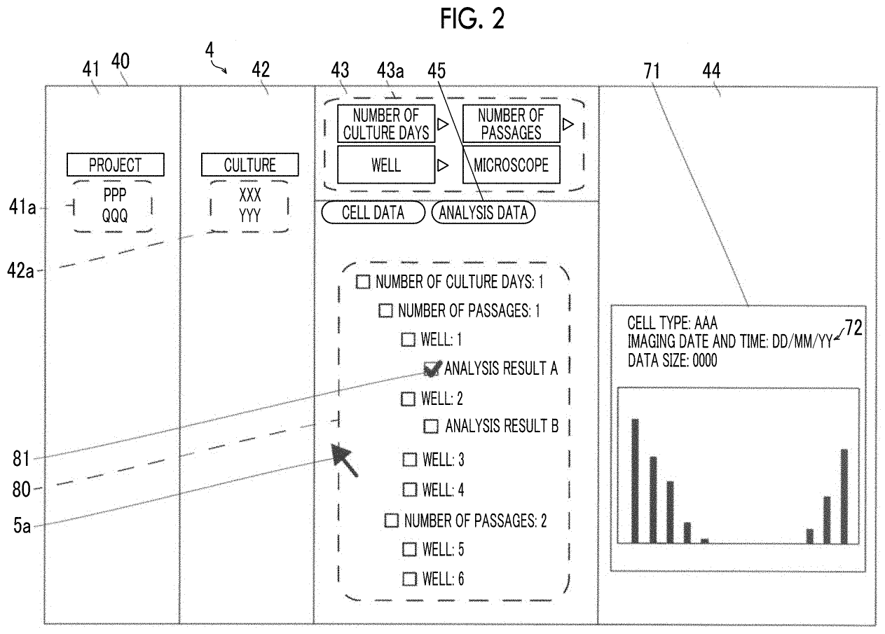

Further, the cell image processing device 1 creates a data tree 80 for the cell image related data 25 in response to the request. Further, the cell image processing device 1 also transmits the created data tree 80 to the computer 2, and displays the data tree 80 on the display unit 4 of the computer 2. The data tree 80 (see FIG. 2) is a virtual data tree in which the cell image related data 25 is classified into two or more hierarchies based on the accompanying information 26 included in the relative data 22. Further, the data tree 80 is configured such that the name of the cell image related data 25 is displayed in a hierarchy of the lowest layer. Note that, the computer 2 including the display unit 4 is an example of a “display terminal” in the claims.

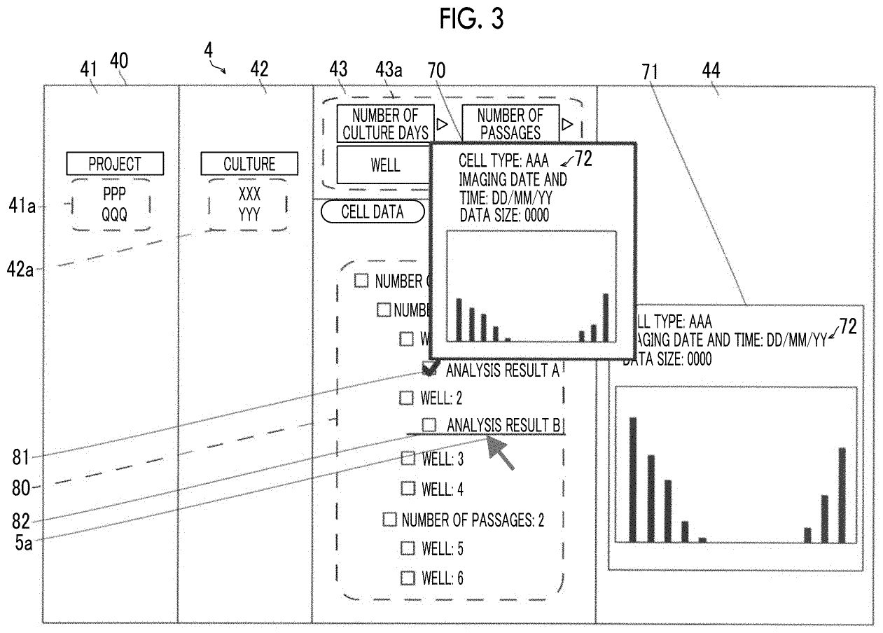

Further, as shown in FIG. 3, the cell image processing device 1 popup displays the cell image related data 25 on the display unit 4 in response to the request. Specifically, the cell image processing device 1 popup displays the cell image related data 25 selected by first selection on the display unit 4. The cell image related data 25 selected by the first selection is popup displayed in the form of a popup display image 70. In FIG. 3, an “analysis result B” selected by the first selection is popup displayed in the form of the popup display image 70.

As shown in FIG. 1, the cell image processing device 1 includes a processor 10 and a storage unit 20.

The processor 10 is configured to analyze the acquired cell image 23, and to generate the analysis result 24. Further, the processor 10 is configured to create the data tree 80 (see FIG. 2) for the cell image related data 25. Further, the processor 10 is configured to popup display the popup display image 70 on the display unit 4 of the computer 2. The processor 10 includes a Central Processing Unit (CPU), a Read Only Memory (ROM), a Random Access Memory (RAM), a Graphics Processing Unit (GPU), or a Field-Programmable Gate Array (FPGA) configured for image processing.

The storage unit 20 stores various programs 21 to be executed by the processor 10. Further, the storage unit 20 is configured to store the relative data 22. The storage unit 20 includes, for example, a non-volatile storage device such as a Hard Disk Drive (HDD) or a Solid State Drive (SSD).

The network 90 connects the cell image processing device 1, the computer 2, and the imaging device 3 so as to be able to communicate with each other. The network 90 is, for example, a Local Area Network (LAN) constructed within a facility. The network 90 may be, for example, the Internet. When the network 90 is the Internet, the cell image processing system 100 may be a system constructed in the form of cloud computing.

The imaging device 3 generates the cell image 23 obtained by imaging a cell. The imaging device 3 can transmit the generated cell image 23 to the computer 2 and/or the cell image processing device 1 via the network 90. The imaging device 3 captures a microscopic image of the cell. The imaging device 3 performs imaging by an imaging method such as a bright field observation method, a dark field observation method, a phase contrast observation method, or a differential interference observation method. One or more types of imaging devices 3 are used according to the imaging method. One or more imaging devices 3 may be provided in the cell image processing system 100.

The computer 2 is a so-called personal computer, and includes a processor and a storage unit. The display unit 4 and an input unit 5 are connected to the computer 2. The display unit 4 is, for example, a liquid crystal display device. The display unit 4 may be an electroluminescence display device, a projector, or a head-mounted display. The input unit 5 is, for example, a mouse. The input unit 5 may be a keyboard or a touch panel. One or more computers 2 are provided in the cell image processing system 100.

As shown in FIG. 2, the display unit 4 of the computer 2 is configured to include, for example, a plurality of display areas 40 in which a plurality of vertically long display areas are arranged side by side. In the embodiment, the display unit 4 of the computer 2 is configured to include four display areas 40 in which four vertically long display areas are arranged side by side. The four display areas 40 are configured with a project information display area 41, a culture information display area 42, a first display area 43 in which the data tree 80 is displayed, a second display area 44 in which a second display area display image 71 selected by second selection is displayed in order from the left side of the display unit 4 when the user looks at the display unit 4. Note that, the cell image related data 25 is displayed in the second display area 44 in the form of the second display area display image 71 when selected by the second selection.

The plurality of display areas may be two, three, or equal to or larger than five. Further, each of the display areas 40 can be selected to be any state of either a display state or a non-display state by operating the input unit 5. When the non-display state is selected in any of the display areas 40, the widths of the other display areas 40 in the display state are expanded.

Here, in the embodiment, the selection of the cell image related data 25 in the data tree 80 includes the first selection and the second selection.

As shown in FIG. 3, the first selection is selection that is executed while the name of the cell image related data 25 in the data tree 80 is superimposed on an input position 5a by the input unit 5. For example, when the input unit 5 is a mouse, the first selection is selection executed while so-called mouseover. Note that, the first selection is not limited to the selection by mouseover. For example, when the input unit 5 is a mouse, the first selection may be selection made by clicking the name of the cell image related data 25 in the data tree 80. In FIG. 3, an analysis result B is selected by the first selection, and the analysis result B is popup displayed in the form of the popup display image 70. Note that, an analysis result A is displayed in the second display area 44.

As shown in FIG. 2, the second selection is input operation selection executed by a predetermined input operation on the cell image related data 25 in the data tree 80 by the input unit 5. On the left side of the names of the cell image related data 25 in the data tree 80 displayed on the display unit 4, check boxes 81 that can be input by the input unit 5 are provided. The second selection is selection executed by an operation of checking the check box 81 by the input unit 5. The second selection is not particularly limited as long as it is a selection method different from the first selection. In FIG. 2, the analysis result A is selected by the second selection, and the analysis result A is displayed in the second display area 44 in the form of the second display area display image 71.

In the project information display area 41, project information 41a input by the operation of the input unit 5 by the user is displayed. The project information 41a is, for example, a project name to which the cell image related data 25 belongs. Note that, the project information 41a is an example of “research and development plan information” in the claims.

The culture information display area 42 displays culture information 42a input by the operation of the input unit 5 by the user. The culture information 42a is various pieces of information related to the cell culture in the cell image related data 25. The culture information 42a includes, for example, information related to media, information related to a cell type, information related to a cultivator, and information related to culture device. Note that, the culture information 42a is not limited thereto.

In the first display area 43, the data tree 80 of the cell image related data 25 created by the cell image processing device 1 is displayed. In the first display area 43, the data tree 80 that is either a cell image data tree or an analysis result data tree is displayed. In the cell image data tree, the cell images 23 are classified into two or more hierarchies. In the cell image data tree, the name of the cell image 23 is displayed in the hierarchy of the lowest layer. In the analysis result data tree, the analysis result 24 is classified into two or more hierarchies. In the analysis result data tree, the name of the analysis result 24 is displayed in the hierarchy of the lowest layer. In the embodiment, the analysis result data tree is displayed in the first display area 43. An “analysis result 24A” and an “analysis result 24B”, which are the names of the analysis result 24, are displayed in the hierarchy of the lowest layer of the analysis result data tree. Either the cell image data tree or the analysis result data tree is configured to be able to be displayed by switching with a tab 45.

In the first display area 43, culture information 43a related to preset culture is further displayed. The culture information 43a is displayed in hierarchical order in the data tree 80. The culture information 43a is various pieces of information related to the cell culture in the cell image related data 25. The culture information 43a includes, for example, information related to the number of passages of a cell, information related to the number of culture days of cells, information related to a well, and information related to a microscope.

In the second display area 44, the cell image related data 25 displayed by the second selection in the data tree 80 is displayed in the form of the second display area display image 71. In the second display area 44, one or more cell images 23 selected by the second selection or one or more analysis results 24 selected by the second selection are displayed. When a plurality of cell images 23 or a plurality of analysis results 24 are displayed in the second display area 44, each of the plurality of cell images 23 or each of the plurality of analysis results 24 are vertically arranged side by side in the second display area 44. The user can view the plurality of cell images 23 or the plurality of analysis results 24 in order by performing an scrolling operation of the input unit 5. Note that, each of the plurality of cell images 23 or each of the plurality of analysis results 24 displayed in the second display area 44 may be arranged in a matrix by reducing the display size.

Note that, the accompanying information 26 (see FIG. 1) of the relative data 22 includes the project information 41a, the culture information 42a displayed in the culture information display area 42, and the culture information 43a displayed in the first display area 43. The data tree 80 is created by classifying the cell image related data 25 into two or more hierarchies based on the accompanying information 26. The details of data tree creation will be described later.

Further, as shown in FIG. 3, the display unit 4 of the computer 2 is configured so that the popup display image 70 is popup displayed. The details of the popup display will be described later.

### Each Functional Block of Processor

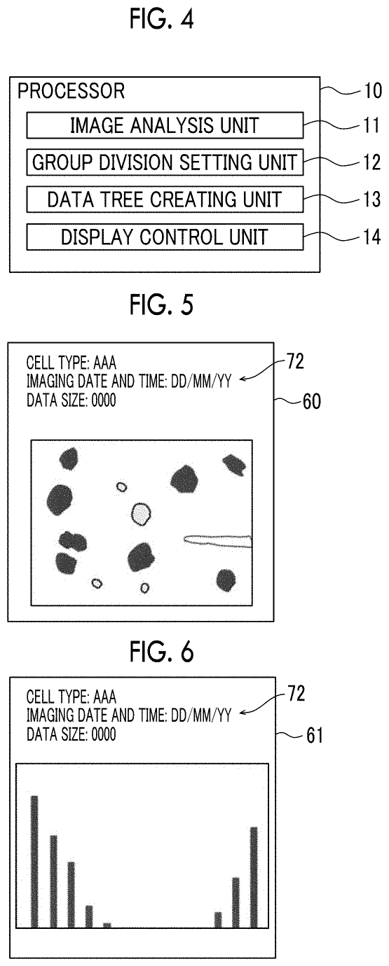

Functional blocks included in the processor 10 will be described with reference to FIG. 4. The processor 10 including the CPU as hardware includes an image analysis unit 11, a group division setting unit 12, a data tree creating unit 13, and a display control unit 14 as the functional blocks of software (program 21). The processor 10 functions as the image analysis unit 11, the group division setting unit 12, the data tree creating unit 13 and the display control unit 14 by executing the program 21 stored in the storage unit 20. The image analysis unit 11, the group division setting unit 12, the data tree creating unit 13, and the display control unit 14 may be separately configured by hardware by providing a dedicated processor 10 (processing circuit). Note that, the image analysis unit 11 is an example of an “acquisition unit” in the claims. Further, the display control unit 14 is an example of a “control unit” in the claims.

The image analysis unit 11 is configured to acquire the cell image 23 generated by the imaging device 3 and to analyze the acquired cell image 23 (see FIG. 1). The image analysis unit 11 is configured, for example, to analyze whether cells appearing in the cell image 23 are differentiated or remain undifferentiated. Note that, an analysis target and analysis content by the image analysis unit 11 are not particularly limited.

The image analysis unit 11 generates the analysis result 24. The image analysis unit 11 associates the cell image 23 with the analysis result 24 obtained by analyzing the cell image 23. The analysis result 24 includes at least one of numerical data (not shown), overlay image data 60 (see FIG. 5) in which analysis result information is superimposed on the cell image, and a graph. The graph includes a graph (not shown) created from the numerical data, and an imaged graph 61 that is a captured image of the graph created from the numerical data. As the popup display image 70, any of the numerical data (not shown), the overlay image data 60 (see FIG. 5), and the imaged graph 61 is displayed. When the imaged graph 61 is popup displayed, the time from the first selection to the popup display can be shortened as compared to a case where the graph is created from the numerical data after the first selection and is popup displayed. As the second display area display image 71, any of the numerical data (not shown), the overlay image data 60 (see FIG. 5), and the graph (not shown) created from the numerical data is displayed.

The group division setting unit 12 is configured to generate the relative data 22 including the cell image 23, the analysis result 24, and one or more pieces of accompanying information 26 input by the user.

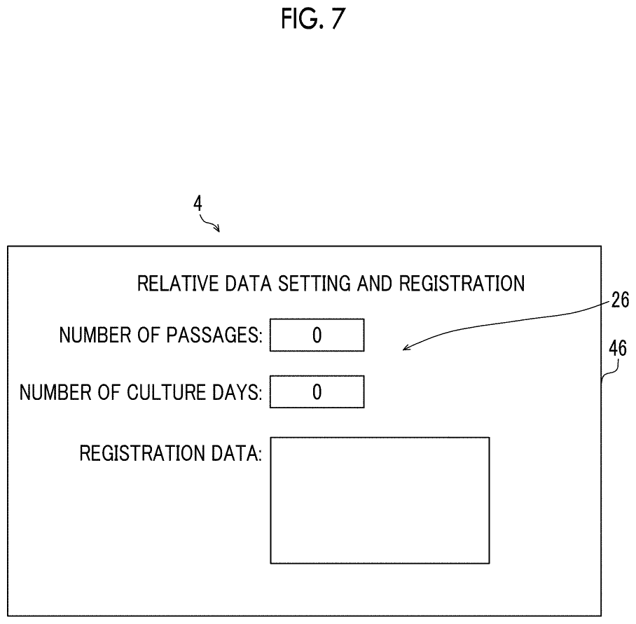

As shown in FIG. 7, the user inputs the accompanying information 26 in a related data setting screen 46 displayed on the display unit 4. In the embodiment, setting is performed so that the data of the cell image 23 is selected by the user as registration data and the number of passages and the number of culture days are input by the user as the accompanying information 26. Note that, the accompanying information 26 set as the accompanying information 26 to be input is not particularly limited as long as information that can be included in the accompanying information 26 described above. The group division setting unit 12 generates the relative data 22 including the cell image 23, the analysis result 24 obtained by analyzing the cell image 23 and stored in the storage unit 20, and one or more pieces of accompanying information 26 input by the user, and registers the relative data 22 in the storage unit 20.

As shown in FIG. 2, the data tree creating unit 13 creates the cell image data tree for classifying the cell image 23 into two or more hierarchies based on the accompanying information 26 included in the relative data 22, and displaying the name of the cell image 23 in the hierarchy of the lowest layer. Further, the data tree creating unit 13 classifies the analysis result 24 into two or more hierarchies based on the accompanying information 26 included in the relative data 22, and creates the analysis result data tree for displaying the name of the analysis result 24 in the hierarchy of the lowest layer.

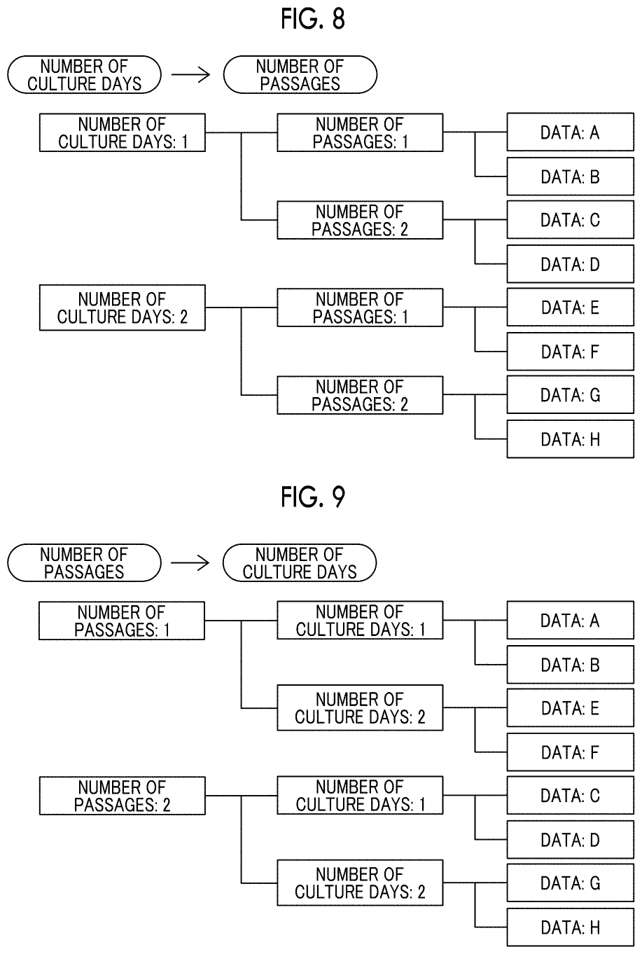

The data tree creating unit 13 performs group division (hierarchy division) for each priority of the preset accompanying information 26. As shown in FIG. 8, for example, when the priority of the accompanying information 26 is set in advance in the order of the number of culture days and the number of passages, the data tree creating unit 13 performs group division on the cell image 23 and the analysis result 24 according to the number of culture days, and, thereafter, performs group division by the number of passages. As a result, the data tree creating unit 13 creates the cell image data tree and the analysis result data tree.

The data tree creating unit 13 is configured to be able to set a new priority of the accompanying information 26 or change the preset priority of the accompanying information 26 by operating the input unit 5. When the relative data 22 includes two or more pieces of accompanying information 26, the data tree 80 includes three or more hierarchies, and, when the setting of the priority of the accompanying information 26 is changed, the data tree creating unit 13 is configured to recreate the data tree 80 based on the priority of the accompanying information 26 after the change.

For example, it is assumed that the priority of the accompanying information 26, which is preset in the order of the number of culture days and the number of passages, is changed in the order of the number of passages and the number of culture days by an operation of changing the setting of the accompanying information 26 by the user. In this case, as shown in FIG. 9, the data tree creating unit 13 performs group division (hierarchy division) on the cell image 23 and the analysis result 24 according to the number of passages. Next, the data tree creating unit 13 performs group division (hierarchy division) according to the number of culture days. As a result, the data tree creating unit 13 recreates the cell image data tree and the analysis result data tree.

As shown in FIG. 3, the display control unit 14 (see FIG. 4) displays the data tree 80 created by the data tree creating unit 13 on the display unit 4 of the computer 2. Further, the display control unit 14 performs control to popup display the cell image related data 25 selected by the first selection by the input unit 5 in the data tree 80 displayed on the display unit 4 in the form of the popup display image 70 on the display unit 4. Further, the display control unit 14 performs control to display the cell image related data 25 selected by the second selection by the input unit 5 in the data tree 80 displayed on the display unit 4 in the form of the second display area display image 71 in the second display area 44.

In a state in which the data tree 80 is displayed in the first display area 43 and the cell image related data 25 selected by the second selection is displayed in the second area in the form of the second display area display image 71, the display control unit 14 is configured to popup display the cell image related data 25 selected by the first selection on the display unit 4 in the form of the popup display image 70.

In the state of the first selection, the display control unit 14 is configured to highlight the name of the cell image related data 25 which is popup displayed. The display control unit 14 highlights the name of the cell image related data 25 which is popup displayed, for example, in a color, a font, and a size which are different from those of a case where the state is not the first selection, or highlights the name of the cell image related data 25 which is popup displayed by attaching an underline 82. Note that, the aspect of the highlight is not limited thereto.

The display control unit 14 is configured to popup display the cell image related data 25 selected by the first selection on the display unit 4 for both the cell image related data 25 displayed in the second display area 44 and the cell image related data 25 not displayed in the second display area 44.

The display control unit 14 is configured to erase the popup display image 70 when the input position 5a by the input unit 5 deviates from the name of the cell image related data 25 in the data tree 80. Note that, the display control unit 14 may be configured to erase the popup display image 70 after a predetermined time elapses since the input position 5a by the input unit 5 deviates from the name of the cell image related data 25 in the data tree 80, or may be configured to erase the popup display image 70 when a delete button provided at the corner of the popup displayed cell image related data 25 is clicked.

The display control unit 14 is configured to display the popup display image 70 so as not to cover all the names of the cell image related data 25 in the data tree 80 and a graph portion in the second display area display image 71. Note that, the position where the popup display image 70 is displayed is not particularly limited. Further, the display size of the popup display image 70 is set in advance. Note that, the display size of the popup display image 70 may be configured to be changeable by the user.

The display control unit 14 is configured to popup display the popup display image 70 including at least one of the cell image related data 25 selected by the first selection and the information 72 related to the cell type, imaging date and time, and data size. Note that, the information included in the popup display image 70 is not limited thereto, and may be, for example, any information included in the accompanying information 26.

### Popup Display Process of Cell Image Related Data

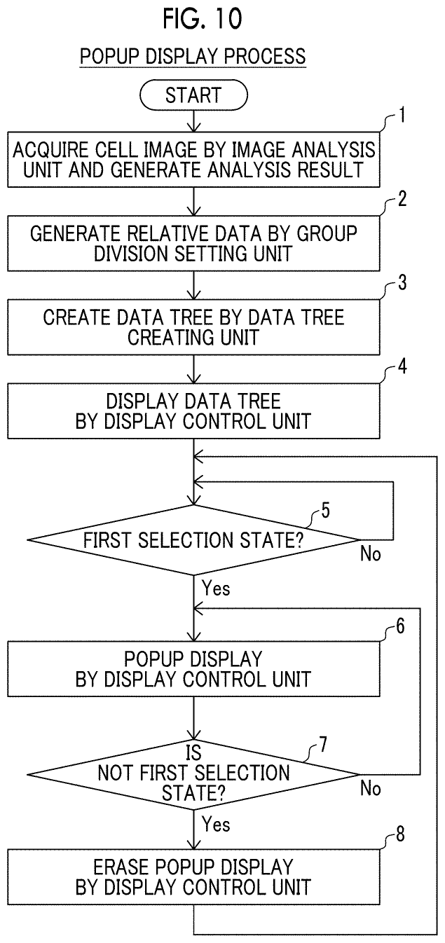

With reference to FIG. 10, a popup display process of the cell image related data 25 according to the present embodiment will be described.

In step S1, the image analysis unit 11 acquires a cell image generated by the imaging device 3, analyzes the acquired cell image, and generates an analysis result 24. After that, the process proceeds to step S2.

In step S2, the group division setting unit 12 generates relative data 22 including the cell image, the analysis result 24 obtained by analyzing the cell image and stored in the storage unit 20, and one or more pieces of accompanying information 26 input by the user, and registers the generated relative data 22 in the storage unit 20. After that, the process proceeds to step S3.

In step S3, the data tree creating unit 13 creates a cell image data tree for classifying the cell image into two or more hierarchies based on the accompanying information 26 included in the relative data 22, and displaying the name of the cell image in the hierarchy of the lowest layer. Further, the data tree creating unit 13 creates the analysis result data tree for classifying the analysis result 24 into two or more hierarchies based on the accompanying information 26 included in the relative data 22, and displaying the name of the analysis result 24 in the hierarchy of the lowest layer. After that, the process proceeds to step S4.

In step S4, the display control unit 14 displays, on the display unit 4 of the computer 2, the data tree 80 of either the cell image data tree or the analysis result 24 data tree, which is selected by the tab 45 of the display unit 4. After that, the process proceeds to step S5.

In step S5, the display control unit 14 determines whether or not the cell image related data 25 is selected by the first selection in a state in which the data tree 80 is displayed in the first display area 43 and the second display area display image 71 is displayed by the second selection in the second area. In a case of a first selection state (Yes in step S5), the process proceeds to step S6, and, in a case of being not the first selection state (No in step S5), the process proceeds to step S5.

In step S6, the display control unit 14 popup displays the cell image related data 25 selected by the first selection on the display unit 4. After that, the process proceeds to step S7.

In step S7, the display control unit 14 determines whether or not the state is the state which is not the first selection. In the case of being not the first selection state (Yes in step S7), the process proceeds to step S8, and, in a case where the first selection state is pending (No in step S5), the process proceeds to step S6.

In step S8, the display control unit 14 erases the popup display of the cell image related data 25 selected by the first selection. After that, the process proceeds to step S5.

Note that, when an analysis work ends in any of steps S5 to S8, the process ends. Further, when the priority of the accompanying information 26 is changed, the process of step S3 is executed again, and the data tree 80 after the priority is changed is displayed on the display unit 4.

### Effects of Present Embodiment

In the present embodiment, the following effects can be obtained.

In the present embodiment, as described above, the cell image processing system 100 includes the cell image processing device 1, the display unit 4 that is configured to be able to communicate with the cell image processing device 1, and the input unit 5 that is connected to the display unit 4. The cell image processing device 1 includes an image analysis unit 11 that acquires cell image related data 25, the storage unit 20 that stores the relative data 22 including the acquired data 25 related to the cell image 23 and one or more pieces of accompanying information 26, the data tree creating unit 13 that creates the data tree 80 for classifying the cell image related data 25 into two or more hierarchies based on the accompanying information 26 included in the relative data 22 and displaying the name of the cell image related data 25 in the hierarchy of the lowest layer, and the display control unit 14 that performs control to display the data tree 80 on the display unit 4 and popup display, on the display unit 4, the cell image related data 25 selected by the first selection by the input unit 5 in the data tree 80 displayed on the display unit 4. As a result, the cell image related data 25 selected by the first selection by the input unit 5 can be popup displayed. Therefore, compared with the case where the cell image related data 25 is displayed in a reduced size, the cell image related data 25 can be displayed in a large display size, so that the visibility of the cell image related data 25 can be improved. Further, compared with the case where the plurality of cell image related data 25 are displayed in order by the scrolling operation, the desired cell image related data 25 can be displayed immediately, so that cell image related data 25 desired to be checked and cell image related data 25 desired to be compared can be visually recognized easily. As a result, the desired cell image related data 25 can be visually recognized more easily, and the analysis work of the cell image 23 can be performed more efficiently.

Further, in the present embodiment, as described above, the display unit 4 is configured to include the first display area 43 in which the data tree 80 is displayed, and the second display area 44 in which the cell image related data 25 selected by the second selection different from the first selection in the data tree 80 is displayed, and the display control unit 14 popup displays the cell image related data 25 selected by the first selection on the display unit 4 in a state in which the data tree 80 is displayed in the first display area 43 and the cell image related data 25 selected by the second selection is displayed in the second display area 44. As a result, even when all the plurality of cell image related data 25 selected by the second selection are not simultaneously displayed in the second display area 44 in the form of the second display area display image 71, the second display area display image 71 that is not displayed in the second display area 44 can be popup displayed in the form of the popup display image 70 by the first selection. Therefore, the analysis work of the cell image 23 can be performed more efficiently.

Further, in the present embodiment, as described above, the display control unit 14 is configured to popup display the cell image related data 25 selected by the first selection on the display unit 4 for both the cell image related data 25 displayed in the second display area 44 and the cell image related data 25 not displayed in the second display area 44. As a result, even the cell image related data 25 which is not selected by the second selection can be popup displayed by the first selection without being displayed in the second display area 44 by the second selection. Therefore, the analysis work of the cell image 23 can be performed further more efficiently.

Further, in the present embodiment, as described above, the first selection is mouseover selection executed while the name of the cell image related data 25 in the data tree 80 displayed on the display unit 4 is superimposed on the input position 5a by the input unit 5, and the second selection is input operation selection executed by a predetermined input operation by the input unit 5 for the cell image related data 25 in the data tree 80 displayed on the display unit 4. As a result, by the first selection which is an easier operation than the second selection, the cell image related data 25 can be easily popup displayed. Therefore, the desired cell image related data 25 can be further visually recognized more easily.

Further, in the present embodiment, as described above, a configuration is made to popup display the popup display image 70 including the cell image related data 25 selected by the first selection and at least one of the information 72 related to the cell type, the imaging date and time, and the data size. As a result, the analysis work of the cell image 23 can be performed further efficiently.

Further, in the present embodiment, as described above, the cell image related data 25 is configured to include cell image 23 and analysis result 24 obtained by analyzing the cell image 23, in which the data tree creating unit 13 creates a cell image data tree for classifying the cell image 23 into two or more hierarchies based on the accompanying information 26 included in the relative data 22 and displaying the name of the cell image 23 in the hierarchy of the lowest layer, and an analysis result data tree for classifying the analysis result 24 into two or more hierarchies based on the accompanying information 26 included in the relative data 22 and displaying the name of the analysis result 24 in the hierarchy of the lowest layer. As a result, since both the data tree 80 of the cell image 23 as the input data in the analysis work and the data tree 80 of the analysis result 24 as the output data in the analysis work are created, it is possible to efficiently check or compare for each cell image or each analysis result.

Further, in the present embodiment, as described above, the popup displayed analysis result 24 includes at least one of the numerical data, the overlay image data 60 in which the analysis result information is superimposed on the cell image 23, and an imaged graph 61. As a result, it is possible for the user to view and easily grasp the content of the popup displayed analysis result 24.

Further, in the present embodiment, as described above, a configuration is made so that the cell image processing device 1 can set the priority of the accompanying information 26, the relative data 22 includes two or more pieces of accompanying information 26, the data tree 80 includes three or more hierarchies, and, when the setting of the priority of the accompanying information 26 is changed, the data tree creating unit 13 recreates the data tree 80 based on the priority of the accompanying information 26 after the change. As a result, the cell image related data 25 can be easily popup displayed even in the recreated data tree 80, so that the convenience of the analysis work of the cell image 23 can be improved.

Further, in the present embodiment, as described above, the accompanying information 26 includes at least one of the project information 41a and the culture information 42a and 43a related to culture. As a result, the data tree 80 customized by the user can be created, so that the convenience of the analysis work of the cell image 23 can be improved.

### Effects of Cell Image Processing Method According to Present Embodiment

Further, the cell image processing method according to the present embodiment, as described above, includes acquiring the cell image related data 25, storing the relative data 22 including the acquired cell image related data 25 and one or more pieces of accompanying information 26, creating the data tree 80 for classifying the cell image related data 25 into two or more hierarchies based on the accompanying information 26 included in the relative data 22 and displaying the name of the cell image related data 25 in the hierarchy of the lowest layer, and displaying the created data tree 80 on the display unit 4, so that the selected cell image related data 25 is popup displayed on the display unit 4 when the cell image related data 25 is selected in the data tree 80 displayed on the display unit 4 by the input unit 5. As a result, the cell image related data 25 selected by the selection by the input unit 5 can be popup displayed. Therefore, compared with the case where the cell image related data 25 is displayed in a reduced size, the cell image related data 25 can be displayed in a large display size, so that the visibility of the cell image related data 25 can be improved. Further, compared with the case where the plurality of cell image related data 25 are displayed in order by the scrolling operation, the desired cell image related data 25 can be displayed immediately, so that cell image related data 25 desired to be checked and cell image related data 25 desired to be compared can be visually recognized easily. As a result, the desired cell image related data 25 can be visually recognized more easily, and the analysis work of the cell image 23 can be performed more efficiently.

### Modification Example

Note that, the embodiments disclosed here should be considered to be exemplary and not restrictive in all aspects. The scope of the present invention is shown by the claims rather than the description of the embodiment described above, and further includes all modifications (modification examples) within the meaning and scope equivalent to the claims.

For example, in the above embodiment, an example is shown in which the display control unit 14 is configured to popup display, on the display unit 4, the cell image related data 25 selected by the first selection in the form of the popup display image 70 in a state in which the data tree 80 is displayed in the first display area 43 and the second display area display image 71 is displayed on the second display area 44. However, the present invention is not limited thereto. When the data tree 80 is displayed in the first display area 43, the display control unit 14 may be configured to popup display the cell image related data 25 selected by the first selection on the display unit 4 even when the second display area display image 71 is not displayed.

Further, in the above embodiment, an example is shown in which the display size of the popup display image 70 is preset. However, the present invention is not limited thereto. For example, the display control unit 14 may be configured to enlarge or reduce the display size of the popup display image 70 based on a scroll wheel operation by the mouse as the input unit 5.

Further, in the above embodiment, an example is shown in which the display control unit 14 is configured to display the popup display image 70 so as not to cover all the names of the cell image related data 25 in the data tree 80 and the graph portion in the second display area display image 71. However, the present invention is not limited thereto. For example, the display control unit 14 may be configured to move the display area of the name of the cell image related data 25 adjacent to the cell image related data 25 selected by the first selection to popup display the popup display image 70 in a space generated by the movement.

Further, in the above embodiment, an example is shown in which the project information display area 41, the culture information display area 42, the first display area 43, and the second display area 44 are displayed in order from the left side of the display unit 4 on the display unit 4. However, each arrangement area is not particularly limited.

Further, in the above embodiment, an example is shown in which the project information 41a, which is input by the operation of the input unit 5 performed by the user, is displayed in the project information display area 41, and an example is shown in which the culture information 42a, which is input by the operation of the input unit 5 performed by the user, is displayed in the culture information display area 42. However, the present invention is not limited thereto. The project information display area 41 and the culture information display area 42 may be configured so that information other than the project information 41a and the culture information 42a can be input.

Further, in the above embodiment, an example is shown in which the cell image data tree in which the name of the cell image 23 is displayed in the hierarchy of the lowest layer and the analysis result data tree in which the name of the analysis result 24 is displayed in the hierarchy of the lowest layer are created. However, the present invention is not limited thereto. A cell image data tree in which the name of the cell image 23 is displayed in a hierarchy other than the lowest layer and an analysis result data tree in which the name of the analysis result 24 is displayed in the hierarchy other than the lowest layer may be created.

Further, in the above embodiment, an example is shown in which the display control unit 14 is configured to popup display the cell image related data 25 selected by the first selection on the display unit 4 for both the cell image related data 25 displayed in the second display area 44 and the cell image related data 25 not displayed in the second display area 44. However, the present invention is not limited thereto. For example, the display control unit 14 may be configured so as not to perform popup display when the cell image related data 25 not displayed in the second display area 44 (not selected by the second selection) is selected by the first selection, and popup display the cell image related data 25 selected by the first selection only when the cell image related data 25 displayed in the second display area 44 (selected by the second selection) is selected by the first selection.

Further, in the above-described embodiment, an example is shown in which the data of the cell image 23 is selected by the user as the registration data in generation of the relative data 22. However, the present invention is not limited thereto. For example, the data of the analysis result 24 may be selected by the user as the registration data.

Further, in the above-described embodiment, an example is shown in which the cell image processing system 100 is constructed in a client-server model. However, the present invention is not limited thereto. For example, the computer 2 may be configured to analyze the cell image 23, generate the analysis result 24, create the data tree 80, and popup display the cell image related data 25 on the display unit 4.

### Aspects

Those skilled in the art understand that the above-described exemplary embodiments are specific examples of the following aspects.

### Item 1

A cell image processing system including:

a cell image processing device;

a display terminal that is configured to be able to communicate with the cell image processing device; and

an input unit that is connected to the display terminal, in which

the cell image processing device includes

an acquisition unit that acquires cell image related data,

a storage unit that stores relative data including the acquired cell image related data and one or more pieces of accompanying information,

a data tree creating unit that creates a data tree for classifying the cell image related data into two or more hierarchies based on the accompanying information included in the relative data and displaying a name of the cell image related data in a predetermined hierarchy, and

a control unit that performs control to display the data tree on the display terminal and popup display, on the display terminal, the cell image related data selected by first selection by the input unit in the data tree displayed on the display terminal.

### Item 2

In the cell image processing system described in item 1, the display terminal includes a first display area in which the data tree is displayed, and a second display area in which the cell image related data selected by second selection different from the first selection in the data tree is displayed, and

the control unit popup displays the cell image related data selected by the first selection on the display terminal in a state in which the data tree is displayed in the first display area and the cell image related data selected by the second selection is displayed in the second display area.

### Item 3

In the cell image processing system described in item 2, the control unit popup displays the cell image related data selected by the first selection on the display terminal for both the cell image related data displayed in the second display area and the cell image related data not displayed in the second display area.

### Item 4

In the cell image processing system described in item 2 or 3, the first selection is mouseover selection executed while the name of the cell image related data in the data tree displayed on the display terminal is superimposed on an input position by the input unit, and the second selection is input operation selection executed by a predetermined input operation by the input unit for the cell image related data in the data tree displayed on the display terminal.

### Item 5

In the cell image processing system described in any of items 1 to 4, the control unit popup displays an image including at least one of the cell image related data selected by the first selection and information related to a cell type, imaging date and time, and a data size.

### Item 6

In the cell image processing system described in any of items 1 to 5, the cell image related data includes cell image data and analysis result data obtained by analyzing the cell image data, and

the data tree creating unit creates a cell image data tree for classifying the cell image data into two or more hierarchies based on the accompanying information included in the relative data and displaying a name of the cell image data in a predetermined hierarchy, and an analysis result data tree for classifying the analysis result data into two or more hierarchies based on the accompanying information included in the relative data and displaying a name of the analysis result data in a predetermined hierarchy.

### Item 7

In the cell image processing system described in item 6, the popup displayed analysis result data includes at least one of numerical data, overlay image data in which analysis result information is superimposed on the cell image data, and an imaged graph.

### Item 8

In the cell image processing system in any of items 1 to 7, the cell image processing device can set priority of the accompanying information,

the relative data includes two or more pieces of the accompanying information, and the data tree includes three or more hierarchies, and

when setting of priority of the accompanying information is changed, the data tree creating unit recreates the data tree based on the priority of the accompanying information after the change.

### Item 9

In the cell image processing system described in any of items 1 to 8, the accompanying information includes at least one of research and development plan information and culture information related to culture.

### Item 10

A cell image processing method including:

acquiring cell image related data;

storing relative data including the acquired cell image related data and one or more pieces of accompanying information;

creating a data tree for classifying the cell image related data into two or more hierarchies based on the accompanying information included in the relative data and displaying a name of the cell image related data in a predetermined hierarchy; and

displaying the created data tree on a display terminal; and

popup displaying, on the display terminal, the selected cell image related data when the cell image related data is selected in the data tree displayed on the display terminal by an input unit.

What is claimed is:

1. A cell image processing system comprising:
a cell image processing device;
a display terminal that is configured to be able to communicate with the cell image processing device; and
an input unit that is connected to the display terminal, wherein
the cell image processing device includes
an acquisition unit that acquires cell image related data,
a storage unit that stores relative data including the acquired cell image related data and one or more pieces of accompanying information,
a data tree creating unit that creates a data tree for classifying the cell image related data into two or more hierarchies based on the accompanying information included in the relative data and displaying a name of the cell image related data in a predetermined hierarchy, and
a control unit that performs control to display the data tree on the display terminal and popup display, on the display terminal, the cell image related data selected by first selection by the input unit in the data tree displayed on the display terminal.

2. The cell image processing system according to claim 1, wherein
the display terminal includes a first display area in which the data tree is displayed, and a second display area in which the cell image related data selected by second selection different from the first selection in the data tree is displayed, and
the control unit popup displays the cell image related data selected by the first selection on the display terminal in a state in which the data tree is displayed in the first display area and the cell image related data selected by the second selection is displayed in the second display area.

3. The cell image processing system according to claim 2, wherein
the control unit popup displays the cell image related data selected by the first selection on the display terminal for both the cell image related data displayed in the second display area and the cell image related data not displayed in the second display area.

4. The cell image processing system according to claim 2, wherein
the first selection is mouseover selection executed while the name of the cell image related data in the data tree displayed on the display terminal is superimposed on an input position by the input unit, and
the second selection is input operation selection executed by a predetermined input operation by the input unit for the cell image related data in the data tree displayed on the display terminal.

5. The cell image processing system according claim 1, wherein
the control unit popup displays an image including the cell image related data selected by the first selection and at least one of information related to a cell type, imaging date and time, and a data size.

6. The cell image processing system according to claim 1, wherein
the cell image related data includes cell image data and analysis result data obtained by analyzing the cell image data, and
the data tree creating unit creates a cell image data tree for classifying the cell image data into two or more hierarchies based on the accompanying information included in the relative data and displaying a name of the cell image data in a predetermined hierarchy, and an analysis result data tree for classifying the analysis result data into two or more hierarchies based on the accompanying information included in the relative data and displaying a name of the analysis result data in a predetermined hierarchy.

7. The cell image processing system according to claim 6, wherein
the popup displayed analysis result data includes at least one of numerical data, overlay image data in which analysis result information is superimposed on the cell image data, and an imaged graph.

8. The cell image processing system according to claim 1, wherein
the cell image processing device can set priority of the accompanying information,
the relative data includes two or more pieces of the accompanying information, and the data tree includes three or more hierarchies, and
when setting of priority of the accompanying information is changed, the data tree creating unit recreates the data tree based on the priority of the accompanying information after the change.

9. The cell image processing system according to claim 1, wherein
the accompanying information includes at least one of research and development plan information and culture information related to culture.

10. A cell image processing method comprising:
acquiring cell image related data;
storing relative data including the acquired cell image related data and one or more pieces of accompanying information;
creating a data tree for classifying the cell image related data into two or more hierarchies based on the accompanying information included in the relative data and displaying a name of the cell image related data in a predetermined hierarchy;
displaying the created data tree on a display terminal; and
popup displaying, on the display terminal, the selected cell image related data when the cell image related data is selected in the data tree displayed on the display terminal by an input unit.
